(19) United States
(12) Patent Application Publication
(10) Pub. No.: US 2002/0171896 A1
(43) Pub. Date: Nov. 21, 2002

(54) Free-space optical communication system employing wavelength conversion

(75) Inventors: Gerald R. Clark, San Diego, CA (US); Brian W. Neff, Solana Beach, CA (US); Richard W. Pecile, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Lightpointe Communications, Inc.

(21) Appl. No.: 09/864,093

(22) Filed: May 21, 2001

(51) Int. Cl. H04B 10/00

(52) U.S. Cl. 359/172; 359/152

(57) ABSTRACT

Free-space optical transceivers employ wavelength conversion from a fiber interface wavelength λ_{fiber} to a free-space transform wavelength λ_{fs} and back again to overcome a broad range of environmental impacts to the free-space optical signal, such as fog. The wavelength conversions may be performed all-optically without the need for electro-optical conversion, or the wavelength conversions may be performed using electro-optical conversion. The performance of the chosen value for the free-space transform wavelength λ_{fs} may be monitored and a feedback control system used to dynamically adjust the value for λ_{fs} until the optimum value for the given atmospheric conditions is achieved. Cooperating transceivers can be informed of a newly selected value for λ_{fs} via a direct, out-of-band control communications channel, or cooperating transceivers can determine the appropriate wavelength transform amount to be applied by an adaptive wavelength selection determination.

### BACKGROUND OF THE INVENTION

1. Field of the Invention

The present invention relates generally to optical communication, and more specifically to free-space optical networking.

2. Discussion of the Related Art

For digital data communications, optical media offers many advantages compared to wired and RF media. Large amounts of information can be encoded into optical signals, and the optical signals are not subject to many of the interference and noise problems that adversely influence wired electrical communications and RF broadcasts. Furthermore, optical techniques are theoretically capable of encoding up to three orders of magnitude more information than can be practically encoded onto wired electrical or broadcast RF communications, thus offering the advantage of carrying much more information.

Fiber optics are the most prevalent type of conductors used to carry optical signals. An enormous amount of information can be transmitted over fiber optic conductors. A major disadvantage of fiber optic conductors, however, is that they must be physically installed.

Free-space atmospheric links have also been employed to communicate information optically. A free-space link extends in a line of sight path between the optical transmitter and the optical receiver. Free-space optical links have the advantage of not requiring a physical installation of conductors. Free-space optical links also offer the advantage of higher selectivity in eliminating sources of interference, because the optical links can be focused directly between the optical transmitters and receivers, better than RF communications, which are broadcast with far less directionality. Therefore, any adverse influences not present in this direct, line-of-sight path or link will not interfere with optical signals communicated.

Despite their advantages, optical free-space links present problems. The quality and power of the optical signal transmitted depends significantly on the atmospheric conditions existing between the optical transmitter and optical receiver at the ends of the link. Rain drops, fog, snow, smoke, dust or the like in the atmosphere will absorb, refract or scatter the optical beam, causing a reduction or attenuation in the optical power at the receiver. Indeed, one of the key issues that plagues free-space optics is fog. The length of the free-space optical link also influences the amount of power attenuation via Beers' Law, longer free-space links will naturally contain more atmospheric factors to potentially attenuate the optical beam than shorter links. Furthermore, optical beams naturally diverge as they travel greater distances. The resulting beam divergence reduces the amount of power available for detection.

If the attenuation of the optical beam is sufficiently great, the ability to recognize the information communicated on a reliable basis is diminished, and the possibility that errors in communication will arise is elevated. Atmospheric attenuation particularly diminishes the probabilities of error-free communications at higher transmission frequencies, because atmospheric attenuation naturally occurs to a greater extent at higher optical frequencies, i.e. shorter wavelengths, than at lower optical frequencies, i.e. longer wavelengths. Thus, in general, lower optical frequencies tend to penetrate fog better than higher optical frequencies.

The more-penetrating free-space optical frequencies are different from those frequencies which are typically employed to transmit information over long-haul fiber optic communication systems. An electro-optical conversion has heretofore been required to convert the fiber link backbone transmission frequency to the free-space transmission frequency. An electro-optical conversion involves converting the higher frequency fiber link backbone optical signals to electrical signals, and then back to optical signals at the lower, more penetrating free-space optical frequency, and vice versa. Additional equipment is required to accomplish the conversion, resulting in an increase in the cost and complexity of the terrestrial optical communications network.

Electro-optical conversions introduce the possibility that errors will be created during the conversion, particularly under the common situation of the fiber optic signal carrying information at multiple wavelengths. Common optical detectors respond to information in a broad frequency range or wavelength band, and this broad-band response destroys the information carried at specific wavelengths. To avoid this problem and to maintain the information present in the different, specific wavelength optical signals, the optical signal must first be filtered into its different wavelength components. Thereafter each different wavelength component must be separately electro-optically converted, and then all of the separate converted components combined back into a single optical signal. The complexity of this process raises the possibilities of introducing errors in the information communicated and increases the costs of the equipment used in the terrestrial optical communication network.

Electro-optical conversion has also been used to amplify the light signals conducted through fiber optic cables. The light signals conducted over fiber cables are attenuated, and it is periodically necessary to amplify those signals in order to maintain signal strength. Recently however, erbium doped fiber amplifiers (EDFAs, and sometimes also referred to as ERDAs) have been developed to amplify the light signals optically, without requiring electro-optical conversion, as the light signals pass through the optical fiber. EDFAs allow light to be amplified in a relatively wide wavelength band (about 30 nanometers (nm)) around a 1.55 micrometer (um) fundamental wavelength. EDFAs are of particular advantage in long haul fiber optic communications systems, because these systems normally operate in the 1.55 um wavelength band. The broad band amplification of EDFAs around the 1.55 um fundamental frequency allows the EDFAs to be integrated into systems using wavelength division multiplexing (WDM), resulting in the ability to communicate separate information at different wavelengths simultaneously in the same fiber. Thus, EDFAs are of particular importance and value in long haul fiber telecommunication systems because electro-optical conversions can be minimized.

It is with respect to these and other background information factors relevant to the field of terrestrial optical communications that the present invention has evolved.

### SUMMARY OF THE INVENTION

The present invention advantageously addresses the needs above as well as other needs by providing a method of communicating optical signals over a free-space link. The method comprising the steps of: receiving a first optical signal having a fiber interface fundamental wavelength from a first single mode optical fiber; converting the fiber interface fundamental wavelength of the first optical signal to a free-space fundamental wavelength with a transmit wavelength transformer; directing the first optical signal having the free-space fundamental wavelength over the free-space link; receiving a second optical signal having the free-space fundamental wavelength from the free-space link; converting the free-space fundamental wavelength of the second optical signal to a fiber interface fundamental wavelength with a receive wavelength transformer; and directing the second optical signal having the fiber interface fundamental wavelength into a second single mode optical fiber.

In another embodiment, the invention provides an apparatus for communicating optical signals over a free-space link. The apparatus comprises: means for receiving a first optical signal having a fiber interface fundamental wavelength from a first single mode optical fiber; a transmit wavelength transformer configured to convert the fiber interface fundamental wavelength of the first optical signal to a free-space fundamental wavelength; a transmitting element configured to direct the first optical signal having the free-space fundamental wavelength over the free-space link; a receiving element configured to receive a second optical signal having the free-space fundamental wavelength from the free-space link; a receive wavelength transformer configured to convert the free-space fundamental wavelength of the second optical signal to a fiber interface fundamental wavelength; and means for directing the second optical signal having the fiber interface fundamental wavelength into a second single mode optical fiber.

In another embodiment, the invention provides a method of communicating optical signals over a free-space link. The method comprises the steps of: receiving a first optical signal having a fiber interface fundamental wavelength from a first single mode optical fiber; amplifying the first optical signal with a multi-wavelength optical amplifier connected in-line with the first single mode optical fiber; attenuating the first optical signal with a variable optical attenuator that is optically coupled to the multi-wavelength optical amplifier; converting the fiber interface fundamental wavelength of the first optical signal to a free-space fundamental wavelength with a transmit wavelength transformer; and directing the first optical signal having the free-space fundamental wavelength over the free-space link.

In another embodiment, the invention provides an apparatus for communicating optical signals over a free-space link. The apparatus comprises: means for receiving a first optical signal having a fiber interface fundamental wavelength from a first single mode optical fiber; a multi-wavelength optical amplifier connected in-line with the first single mode optical fiber for amplifying the first optical signal; a variable optical attenuator that is optically coupled to the multi-wavelength optical amplifier for attenuating the first optical signal; a transmit wavelength transformer configured to convert the fiber interface fundamental wavelength of the first optical signal to a free-space fundamental wavelength; and one or more transmitting elements configured to direct the first optical signal having the free-space fundamental wavelength over the free-space link.

In another embodiment, the invention provides a method of communicating optical signals over a free-space link. The method comprises the steps of: receiving a first optical signal having the free-space fundamental wavelength from the free-space link; converting the free-space fundamental wavelength of the first optical signal to a fiber interface fundamental wavelength with a receive wavelength transformer; amplifying the first optical signal with a multi-wavelength optical amplifier optically coupled to the receive wavelength transformer; attenuating the first optical signal with a variable optical attenuator that is optically coupled to the multi-wavelength optical amplifier; and directing the first optical signal having the fiber interface fundamental wavelength into a first single mode optical fiber.

In another embodiment, the invention provides an apparatus for communicating optical signals over a free-space link. The apparatus comprises: a receiving element configured to receive a first optical signal having the free-space fundamental wavelength from the free-space link; a receive wavelength transformer configured to convert the free-space fundamental wavelength of the first optical signal to a fiber interface fundamental wavelength; a multi-wavelength optical amplifier optically coupled to the receive wavelength transformer for amplifying the first optical signal; a variable optical attenuator that is optically coupled to the multi-wavelength optical amplifier for attenuating the first optical signal; and means for directing the first optical signal having the fiber interface fundamental wavelength into a first single mode optical fiber.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a block diagram illustrating a pair of free-space optical transceivers made in accordance with an embodiment of the present invention;

FIGS. 2 and 3 are schematic diagrams illustrating transmit and receive portions, respectively, made in accordance with an embodiment of the present invention that may be used in the transceivers shown in FIG. 1;

FIGS. 4 and 5 are schematic diagrams illustrating transmit and receive portions, respectively, made in accordance with another embodiment of the present invention that may be used in the transceivers shown in FIG. 1;

FIG. 6 is a block diagram illustrating an exemplary optical parametric oscillator (OPO) design that may be used for the OPO shown in FIG. 4;

FIGS. 7 and 8 are schematic diagrams illustrating transmitter and receiver modifications, respectively, made in accordance with another embodiment of the present invention that may be used in the transmit and receive portions shown in FIGS. 2, 3, 4 and 5;

FIG. 9 is a schematic diagram illustrating a transceiver made in accordance with another embodiment of the present invention that may be used for the transceivers shown in FIG. 1;

FIG. 10 is a flowchart illustrating an exemplary dynamic wavelength selection control method in accordance with an embodiment of the present invention;

FIG. 11 is a schematic diagram illustrating a transceiver made in accordance with another embodiment of the present invention that may be used for the transceivers shown in FIG. 1;

FIG. 12 is a schematic diagram illustrating a transceiver made in accordance with yet another embodiment of the present invention that may be used for the transceivers shown in FIG. 1;

FIG. 13 is a block diagram illustrating an exemplary version of a receive portion made in accordance with yet another embodiment of the present invention that may be used in the transceivers shown in FIG. 1;

FIGS. 14 and 15 are block diagrams illustrating the receive portion shown in FIG. 13 in further detail;

FIG. 16 is an isometric diagram illustrating an exemplary version of a portion of a receive portion made in accordance with yet another embodiment of the present invention that may be used in the transceivers shown in FIG. 1; and

FIGS. 17, 18, 19, 20 and 21 are block diagrams illustrating the receive portion shown in FIG. 16 in further detail.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

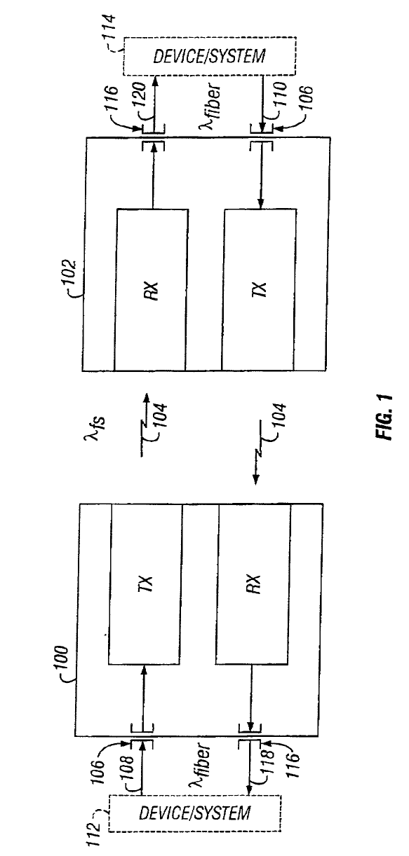

Referring to FIG. 1, there is illustrated a pair of free-space optical transceivers 100, 102 made in accordance with an embodiment of the present invention. The transceivers 100, 102 are ideal for communicating data over a free-space optical link 104 and can do so during nearly any weather, and specifically fog.

In the illustrated embodiment, each of the transceivers 100, 102 includes a transmit portion TX and receive portion RX. Each transmit portion TX includes a connector 106 or the like for connecting directly to a fiber optic conductor, which typically comprises a single mode fiber (SMF) optic cable. The transmit SMF fiber optic cable connecting to transceiver 100 is designated by 108, and the transmit SMF fiber optic cable connecting to transceiver 102 is designated by 110. The SMF fiber optic cables 108, 110 operate at a fiber interface wavelength λ_{fiber} and may be coupled to external devices and/or systems 112, 114, such as for example a long-haul fiber optic communication system(s). By way of example, the fiber interface wavelength λ_{fiber} may be equal to a 1550 nanometer (nm) fundamental wavelength, a 1310 nm fundamental wavelength, or some other wavelength.

Similarly, each receive portion RX of the transceivers 100, 102 includes a connector 116 or the like for connecting directly to a fiber optic conductor, such as an SMF fiber optic cable, operating at the fiber interface wavelength λ_{fiber}. The receive SMF fiber optic cable connecting to transceiver 100 is designated by 118, and the receive SMF fiber optic cable connecting to transceiver 102 is designated by 120. Similar to the SMF fiber optic cables 108, 110, the SMF fiber optic cables 118,120 may be coupled to external devices and/or systems 112, 114, which may comprise a long-haul fiber optic communication system(s). As will be discussed below, a controller is provided within each transmit and receive portion TX, RX to achieve the required interface power specification for the devices and/or systems 112, 114 connected to the connectors 106, 116.

As discussed above, free-space optics as a technology is severely impacted by the presence of fog and other atmospheric disturbances that can extinguish a photon. Specific examples of atmospheric conditions include fog, rain, wind, heat shimmer, and pollutants. The present invention overcomes this atmospheric limitation while still operating with standard fiber optic cable at the user interfaces. Specifically, in accordance with the present invention, the transceivers 100, 102 are capable of interfacing with their respective fiber optic conductors at the fiber interface wavelength λ_{fiber}, and then conducting free-space optical communications at a preferred free-space transformed wavelength λ_{free-space}, or simply λ_{fs}, that is optimal for penetrating fog and the like. In order to perform this function, the transceivers 100, 102 perform a wavelength conversion from the fiber interface wavelength λ_{fiber} to the preferred free-space transformed wavelength λ_{fs}, and then back again. For example, the transmit portion TX of each of the transceivers 100, 102 is configured to convert the wavelength of an optical signal from λ_{fiber} to λ_{fs} and direct the optical signal over the free-space link 104. The receiver portion RX of each of the transceivers 100, 102 is configured to receive the optical signal and reproduce exactly the same signal at the desired interface wavelength by converting the wavelength of the optical signal from λ_{fs} to λ_{fiber}. Thus, the transceivers 100, 102 direct optical signals that originate from optical fibers through a free-space link using appropriate wavelengths to overcome the atmospheric conditions, both man-made and natural.

As used herein, the term “fundamental wavelength” and the variables λ_{fiber}, λ_{free-space}, and λ_{fs} are intended to include a wavelength band having multiple wavelengths around the indicated fundamental wavelength that will be treated as a contiguous spectrum for amplification and conversion.

Wavelength conversion from fiber interface wavelength λ_{fiber} to a preferred transformed wavelength λ_{fs} and pulse shaping is performed to overcome a broad range of environmental impacts to the free-space optical signal. The transformed wavelength to be propagated between optical transceivers through the atmosphere is chosen specifically to overcome a plurality of conditions that could degrade the laser beam used for optical communications. By way of example, a preferred transformed wavelength λ_{fs} having a value in the midwave infra red (MWIR) range, such as 3.5 um, has been found to be ideal for overcoming fog. It should be well understood, however, that the preferred transformed wavelength λ_{fs} may comprise many different values in accordance with the present invention, and in fact, as will be described below, the preferred transformed wavelength λ_{fs} may be time varying according to a dynamic wavelength selection control method of the present invention. Thus, by conducting free-space optical communications at the preferred transformed wavelength λ_{fs} that is optimal for penetrating fog and the like, the transceivers 100, 102 provide an all weather free-space optics communication system.

In accordance with some embodiments of the present invention, the wavelength conversions (transformations) performed by the transceivers 100, 102 are performed all-optically without the need for electro-optical conversion. Because no electro-optical conversion takes place in these embodiments of the transceivers 100, 102, they may be referred to as “all-optical transceivers”, or an “all-optical system”, or performing the wavelength conversions “all-optically”. By performing the wavelength transformation all-optically, these embodiments of the present invention avoid problematic and costly electro-optical conversion.

In accordance with other embodiments of the present invention, on the other hand, the wavelength conversions performed by part or all of the transceivers 100, 102 may be performed by using electro-optical conversion. For example, in some embodiments of the present invention the wavelength conversion performed by the transmit portion TX is performed all-optically, while the wavelength conversion performed by the receive portion RX is performed using electro-optical conversion. In these embodiments of the present invention the optical signal having the preferred transformed wavelength λ_{fs} is received by the receive portion RX and converted to an electric signal. The electric signal is then used to generate an optical signal having the fiber interface wavelength λ_{fiber}.

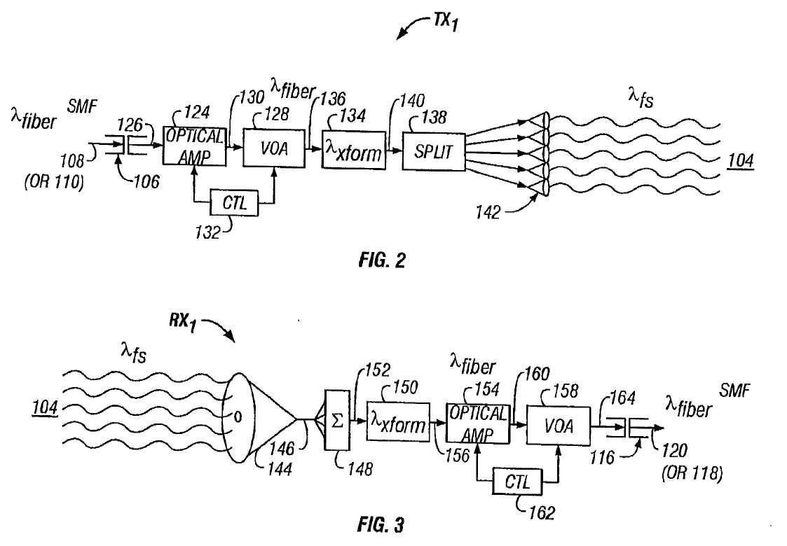

Referring to FIGS. 2 and 3, there is illustrated exemplary versions of transmit and receive portions TX₁, RX₁, respectively, made in accordance with an embodiment of the present invention. The transmit and receive portions TX₁, RX₁ may be used in the transceivers 100, 102. Regarding the transmit portion TX₁ shown in FIG. 2, in this version the connector 106 is coupled to a multi-wavelength optical (or fiber) amplifier 124 via a fiber optic cable 126. One example of a multi-wavelength optical amplifier that may be used in the present invention is an erbium doped fiber amplifier (EDFA). It should be well understood, however, that the multi-wavelength optical amplifier 124 may comprise any type of optical (or fiber) amplifier that can support multiple wavelengths. In other words, any type of fiber amplifier that is capable of amplifying all of the different wavelengths in a particular band may be used as the multi-wavelength optical amplifier 124. For example, with such multi-wavelength optical amplifiers, a particular band in the 1550 nm space can be chosen, such as the C, S or L band, and the multi-wavelength optical amplifier will amplify all of the many wavelengths in the band. Such multi-wavelength optical amplifiers are typically also capable of handling coarse wavelength division multiplexing (CWDM) and dense wavelength division multiplexing (DWDM). Furthermore, while EDFAs provide sufficient amplification, the multi-wavelength optical amplifier 124 may also be doped with materials that allow it to operate over wide temperature ranges, such as for example, Tellurium (Te), that enable operation out of doors.

The multi-wavelength optical amplifier 124 is coupled to a variable optical attenuator (VOA) 128 via a fiber optic cable 130. The VOA 128 smoothes and/or provides dampening to the power gain of the multi-wavelength optical amplifier 124. The VOA 128, which for example may have a dynamic range of 30-40 dB, includes an electrical interface that is controlled by a controller 132. The controller 132 includes logic that is used to intelligently control the VOA 128 according to the system demands. Pursuant to this intelligent control scheme, the controller 132 communicates the desired level of attenuation to the VOA 128. Thus, the controller 132 controls the power gain of the multi-wavelength optical amplifier 124 and the dynamic attenuation provided by the VOA 128 to achieve the required interface power specification for the externally connected devices and/or systems 112, 114 (FIG. 1) and to overcome amplitude variations due to scintillation.

The VOA 128 chosen for this application preferably has a very fast response and settling time, on the order of microseconds. In this case, it can be used in conjunction with the intelligent gain controller 132 to smooth the amplitude jitter introduced by the atmosphere. This smoothing effect will improve the performance of either an electro-optical receiver within the free-space optical link or in a downstream optical platform that recovers the signal through an optical to electrical conversion.

By way of example, the intelligent gain control provided by the controller 132 may be based on the measured power of, or control information included in, optical signals received over the free-space link 104, but this is not required. By way of further example, the intelligent control provided by the controller 132 may utilize, or be similar to, the adaptive power control techniques described in U.S. patent application Ser. No. 09/065,685, filed Apr. 24, 1998, entitled TERRESTRIAL OPTICAL COMMUNICATION NETWORK OF INTEGRATED FIBER AND FREE-SPACE LINKS WHICH REQUIRES NO ELECTRO-OPTICAL CONVERSION BETWEEN LINKS, by inventor Heinz Willebrand, the entire contents of which are hereby fully incorporated into the present application by reference, but again this is not required.

The VOA 128 is coupled to a wavelength transformer (or converter) 134 via a fiber optic cable 136. The wavelength transformer 134, the operation of which will be described below, is coupled to a beam splitter 138 via a fiber optic cable 140. The beam splitter 138 is coupled to one or more transmitting elements 142, which direct the optical data over the free-space link 104. The transmitting elements 142 will typically comprise collimating lenses.

The receive portion RX₁ shown in FIG. 3 includes one or more receiving elements 144, which receive the optical data from the free-space link 104. Each receiving element 144 is coupled to a focus element 146 followed by a fiber combiner 148. The focus element 146 may comprise, for example, a tapered piece of fiber or a micro-lens array. The receiving element 144, the focus element 146, and the fiber combiner 148 will all be described in greater detail below.

The fiber combiner 148 is coupled to a wavelength transformer (or converter) 150 via a fiber optic cable 152. The wavelength transformer 150, the operation of which will be described below, is coupled to a multi-wavelength optical (or fiber) amplifier 154 via a fiber optic cable 156. Similar to as described above, it should be well understood that the multi-wavelength optical amplifier 154 may comprise any type of optical (or fiber) amplifier that can support multiple wavelengths. An EDFA is one example of such multi-wavelength optical amplifier.

The multi-wavelength optical amplifier 154 is coupled to a VOA 158 via a fiber optic cable 160. Similar to the VOA 128, the VOA 158 smoothes and/or provides dampening to the power gain of the multi-wavelength optical amplifier 154. The VOA 158 and the multi-wavelength optical amplifier 154 are controlled by a controller 162 that includes logic that is used to intelligently control the devices according to the system demands. As mentioned above, such intelligent control may be based on the measured power of, or control information included in, optical signals received over the free-space link 104. The VOA 158 chosen for this application preferably has a very fast response and settling time, on the order of microseconds, and can be used in conjunction with the intelligent gain controller 162 to smooth the amplitude jitter introduced by the atmosphere and to overcome amplitude variations due to scintillation. Furthermore, the VOA 158, along with the controller 162, produces an optical automatic gain control (optical AGC). By using this optical AGC, power can be controlled without the need for communicating power control data through a separate wavelength or through an out of band means or otherwise.

Finally, the VOA 158 is coupled to the connector 116 via a fiber optic cable 164. With respect to the devices and/or systems 112, 114 connected to the connectors 116, the controllers 162 control the power gain of the multi-wavelength optical amplifier 154 and the attenuation provided by the VOA 158 to achieve the required interface power specification for such externally connected devices and/or systems. During operation, the transmit portion TX₁ (FIG. 2) receives an optical signal through the connector 106 from the SMF fiber optic cable 108 (or 110). The wavelength of this optical signal is equal to the fiber interface wavelength λ_{fiber}. The optical amplifier 124 is preferably capable of amplifying any fiber interface wavelength λ_{fiber} prior to sending the signal to the wavelength transformer 134. The optical amplifier 124 may also shorten the output pulse length to create ultrafast pulses, which will be described in further detail below. The wavelength transformer 134 converts λ_{fiber} to the preferred transformed wavelength λ_{fs}. Once split by the beam splitter 138, the new wavelength is transmitted by the transmit portion TX₁ over the free-space optical link 104 to the receive portion RX₁. The signal, still at the preferred transformed wavelength λ_{fs}, is collected by the one or more receiving elements 144 of the receive portion RX₁ and then recombined. The wavelength transformer 150 converts the free-space optical wavelength λ_{fs} to the fiber interface wavelength λ_{fiber}. The converted optical signal is then further conditioned by the receive portion RX₁ before being produced at the output connector 116. The signal produced at the output connector 116 is the original signal having the fiber interface wavelength λ_{fiber}, which may also contain a plurality of wavelengths as coarse wavelength division multiplexing (CWDM) or dense wavelength division multiplexing (DWDM).

The receive portion RX₁ design includes unique optical concentrators that function for various wavelengths that are broadband in nature. Specifically, each transmitted wavelength spectrum that is sent through the terrestrial atmosphere may contain one or more wavelengths that are up and down-converted to the desired optical couplers and amplifiers designed for a given wavelength. For example, λ_{fiber} may actually represent several (e.g. four) distinct wavelengths that are multiplexed into the fiber and that are centered, for example, at or near 1550 nm. Similarly, λ_{fs} may actually represent several distinct wavelengths that are multiplexed and that are centered, for example, at or near 3800 nm. Thus, the wavelength transformers 134, 150 preferably comprise wavelength conversion devices that are capable of handling large numbers of wavelengths multiplexed together during both the up-conversion and down-conversion process. In particular, both single wavelength and multiple wavelengths are capable of being transformed, including CWDM and DWDM. The wavelength transformers 134,150 preferably include narrowband filters that are wide enough to pass DWDM signals.

More specifically, a single mode fiber (SMF) is capable of carrying multiple wavelengths that will be treated as a contiguous spectrum for amplification and conversion from λ_{fiber} to λ_{fs}. Thus, a CWDM or DWDM signal composed of N wavelengths will be passed through the entire optical path at both ends of the user interface. The spectrum will be filtered such that none of the wavelengths contained therein are rejected, but rather passed as a unit.

As mentioned above, in some embodiments of the present invention the wavelength conversions are performed all-optically without the need for electro-optical conversion, and in other embodiments of the present invention some or all of the wavelength conversions are performed by using electro-optical conversion. Specifically, in the all-optical embodiments the wavelength transformers 134, 150 comprise devices that perform the wavelength conversions all-optically, and in the other embodiments either or both of the wavelength transformers 134, 150 comprise devices that perform the wavelength conversions using electro-optical conversion.

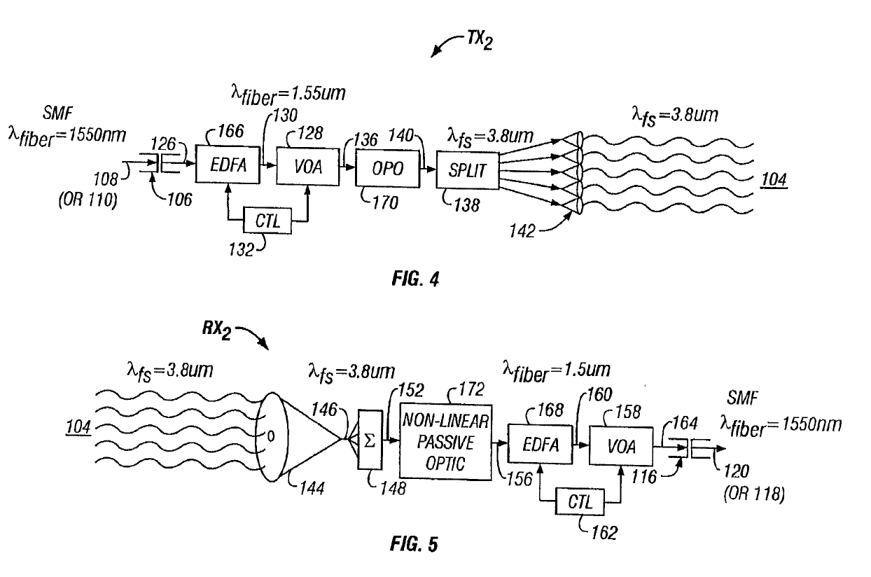

An example of an all-optical embodiment of the present invention will now be described. Referring to FIGS. 4 and 5, there is illustrated exemplary versions of transmit and receive portions TX₂, RX₂, respectively, made in accordance with an embodiment of the present invention. The transmit and receive portions TX₂, RX₂, which may be used in the transceivers 100, 102, perform the wavelength conversions all-optically.

The transmit portion TX₂ is capable of receiving optical data from a fiber optic system and transmitting that data over the free-space optical link 104 with no electro-optical conversion. This way, optical data carried by a long-haul fiber optic communication system may be optically coupled into the SMF fiber optic cables 108, 110, and from there the optical data is transmitted over the free-space link 104, all with no electro-optical conversion. The term “optically coupled” as used herein means coupled using no electro-optical conversion. Similarly, the receive portion RX₂ is capable of receiving optical data from the free-space optical link 104 and providing that data to a fiber optic system with no electro-optical conversion. This way, optical data received from the free-space link 104 may be optically coupled into the SMF fiber optic cables 118, 120 and into a long-haul fiber optic communication system, all with no electro-optical conversion. Therefore, the transmit and receive portions TX₂, RX₂ form an all-optical link that can perform any function that may be performed over fiber, including single and multiple wavelengths spaced along various grids and both coarse and dense configurations inclusive.

While optical data carried by the SMF fiber optic cables 118, 120 may be optically coupled into a long-haul fiber optic communication system, it should be well understood that optical data carried by the SMF fiber optic cables 118, 120 may of course also be split off and converted into electrical signals for use in computers, processing equipment, telephones, etc. Indeed, one or more of the devices and/or systems 112, 114 may comprise devices and/or systems that do perform electro-optical conversion.

In the illustrated versions of the transmit and receive portions TX₂, RX₂, the multi-wavelength optical amplifiers 124, 154 comprise EDFAs 166, 168, respectively, and the wavelength transformers 134, 150 comprise nonlinear optics. For example, the wavelength transformer 134 comprises an optical parametric oscillator (OPO) 170, and the wavelength transformer 150 comprises a nonlinear passive optic such as a frequency doubling crystal 172. Furthermore, in this example, the fiber interface wavelength λ_{fiber}=1550 nm, and the preferred transformed wavelength λ_{fs}=3824 nm (or 3.824 micron). Thus, during operation the OPO 170 converts the 1550 nm wavelength to the 3824 nm preferred transform wavelength λ_{fs}, and the signal is then directed over the free-space link 104 to the receive portion RX₂. The crystal 172 converts the 3824 nm wavelength back to the 1550 nm fiber interface wavelength λ_{fiber} and the signal is directed into the SMF cable 120 (or 118). The wavelength conversion (transformation) performed by the nonlinear optics 170, 172 is performed all-optically without the need for electro-optical conversion.

The 3824 nm wavelength is one preferred value for the preferred transform wavelength λ_{fs} because it has been found to be highly effective in overcoming atmospheric conditions. Specifically, the 3824 nm wavelength is ideal for penetrating fog. Furthermore, the 1550 nm wavelength is one preferred value for the fiber interface wavelength λ_{fiber} because, as mentioned above, 1550 nm is the fundamental operating wavelength of EDFAs and many long haul fiber optic communications systems. Indeed, 1550 nm is a very common SMF fiber interface wavelength. However, while 3824 nm and 1550 nm are exemplary values for λ_{fs} and λ_{fiber}, respectively, it should be well understood that many other values for λ_{fs} and λ_{fiber} may be used in accordance with the present invention. In fact, as will be discussed below, the present invention optionally provides the ability to monitor the performance of the chosen value for λ_{fs} through the atmosphere, and using a feedback control system, dynamically adjust the value for λ_{fs} until the optimum value for the given atmospheric conditions is achieved.

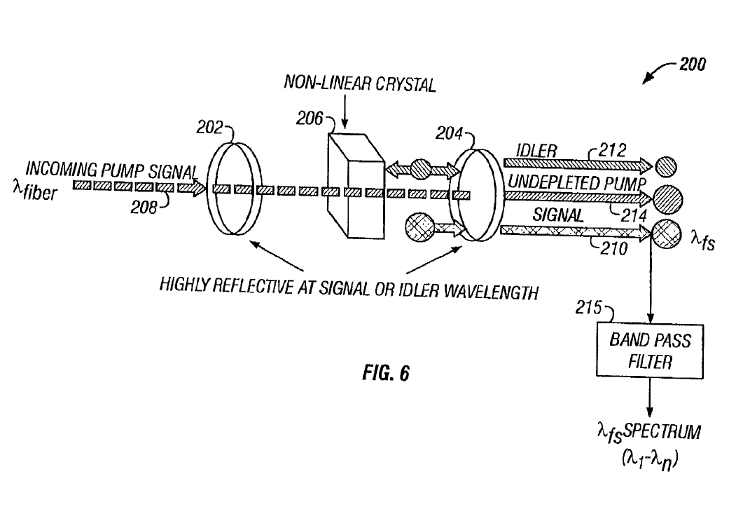

Referring to FIG. 6, there is illustrated an exemplary optical parametric oscillator (OPO) 200 design that may be used for the OPO 170. The OPO 200 transforms an incoming wavelength to an alternative wavelength all-optically without using electro-optical conversion. The OPO 200 includes two reflective surfaces 202, 204 located at each end of an oscillation chamber. A non-linear crystal 206 is located in the oscillation chamber between the two reflective surfaces 202, 204.

During operation an incoming pump signal 208 is supplied through the first reflective surface 202 at one end of the oscillation chamber. An example of a pump signal is a wavelength that contains the payload data at the fiber interface wavelength λ_{fiber}, such as for example λ_{fiber}=1550 nm. This wavelength is to be transformed to an alternative wavelength, such as the preferred transformed wavelength λ_{fs}, which is represented by the output signal 210 that is output from the OPO 200.

Other signals related to the OPO 200 are an idler signal 212 and a non-depleted pump signal 214. An oscillation is established between the two reflective surfaces 202, 204. The surfaces 202, 204 are highly reflective at the wavelength of the output signal 210 or the idler signal 212. When only one of these wavelengths is targeted for oscillation, it is termed a single resonant oscillator (SRO). Using reflective surfaces that cause the wavelengths of both the output signal 210 and the idler signal 212 to oscillate is termed a doubly resonant oscillator (DRO). When the idler signal 212 is oscillated, the output from the chamber is the desired output signal 210 (having the new, alternative wavelength, such as λ_{fs}), the idler signal 212, and some energy in the non-depleted pump signal 214. The desired output signal 210 is passed through a wavelength bandpass filter 215 to remove the idler and the pump wavelengths. The filter 215 is preferably wide enough to permit multiple wavelengths to pass as in a DWDM application. This output signal 210 is then used to carry the communication data over free space, such as the free-space link 104 (FIG. 1).

The non-linear crystal 206 performs the transformation in the oscillation chamber. By way of example, the non-linear crystal 206 may comprise Lithium Niobate (LiNbO₃) or Periodically Poled Lithium Niobate (PPLN). Lithium Niobate crystals have a number of unique properties. Specifically, Lithium Niobate is simultaneously ferro-electric, piezoelectric, and pyro-electric, and it has highly nonlinear optical and electro-optical coefficients and photo-refractive sensitivity. These properties enable Lithium Niobate crystals to be used widely in optical and acoustic devices. These properties are determined by the crystal structure of Lithium Niobate, which is sensitive to physical and chemical effects.

By way of further example, the OPO 170 may be constructed and operated in accordance with the disclosure and teachings of U.S. Pat. No. 6,219,363, issued Apr. 17, 2001, entitled METHOD OF FREQUENCY CONVERSION OF THE RADIATION OF A PULSED OPTICAL PARAMETRIC OSCILLATOR (OPO) AND DEVICE FOR EXECUTING THE METHOD, by inventors Fix et al., the entire contents of which are hereby fully incorporated into the present application by reference.

An example of an embodiment of the present invention that utilizes electrical-to-optical (or simply electro-optical) conversion will now be described. Specifically, in accordance with various embodiments of the present invention the wavelength transformation process may be performed in a mixed manner with both passive optics and electrical conversion in the optical transceiver. For example, the wavelength transformation process may be performed all-optically in the transmit portion TX, but electro-optical conversion may be employed in the wavelength transformation process in the receive portion RX.

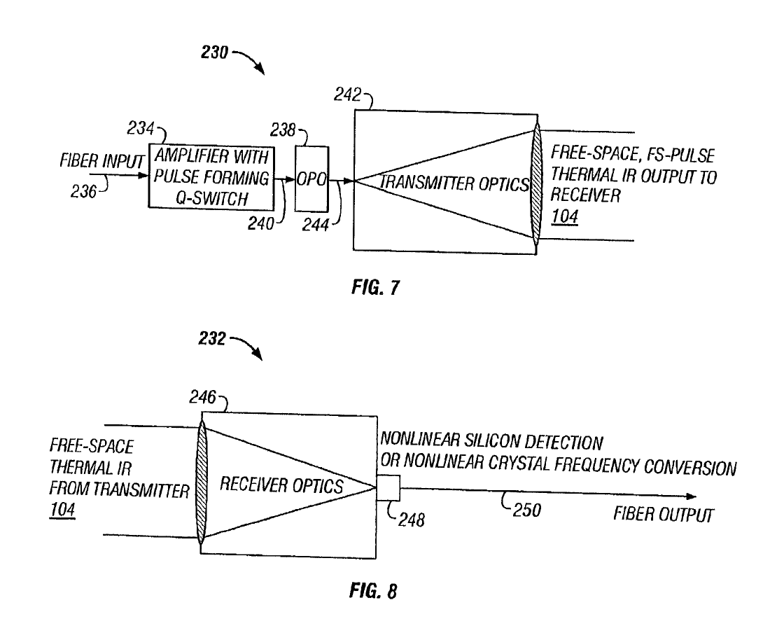

For example, FIG. 7 illustrates exemplary transmitter modifications 230 in accordance with an embodiment of the present invention that may optionally be used in any of the transmit portions TXₙ described herein. FIG. 8 illustrates exemplary receiver modifications 232 in accordance with an embodiment of the present invention that may optionally be used in any of the receive portions RXₙ described herein. The transmitter and receiver modifications 230, 232 form a fempto second midwave infrared (MWIR) transceiver in which the transmitter remains all-optical but the receiver performs optical-to-electrical conversion.

With respect to the transmitter modifications 230, pulse forming optics are incorporated in the transmission frequency converter/laser cavity to shorten the transmission pulse length to fempto seconds. For example, an amplifier 234 having a pulse forming Q-switch receives an optical signal via a fiber optic cable 236. An OPO 238 is optically coupled to the amplifier 234 via a fiber optic cable 240. Transmitter optics 242 are optically coupled to the OPO 238 via a fiber optic cable 244. The OPO 238 performs the wavelength conversion process all optically without the need for electro-optical conversion. The pulse forming optics in the transmitter modifications 230 create higher peak energy for use in the receiver modifications 232.

The receiver modifications 232 can take advantage of the higher peak energy provided by the pulse forming optics in the transmitter modifications 230 in two ways. Specifically, the receiver modifications 232 include receiver optics 246 and a device 248 coupled to a fiber optic cable 250. The device 248 may comprise either a nonlinear silicon detection device or a nonlinear crystal frequency conversion device. The nonlinear silicon detection device is used for converting optical signals into electrical signals, and the nonlinear crystal frequency conversion device is used for wavelength conversion of optical signals in an all-optical manner. Thus, depending on the component used for the device 248, the receiver modifications 232 can perform the wavelength transformation process either all-optically or by using electro-optical conversion.

For the scenario where the device 248 comprises a nonlinear crystal frequency conversion device, the high peak power provided by the pulse forming optics in the transmitter modifications 230 is beneficial for efficiently driving a frequency doubling crystal to up-convert the wavelength from Midwave Infrared (MWIR) 3.1 um back to Near Infrared (Near IR) 1.55 um before amplifying with an optical amplifier, such as the optical amplifier 154 (FIG. 3) or the EDFA 168 (FIG. 5). It is noted that MWIR generally includes wavelengths falling in the 3 to 11 um range and that 3.1 um also penetrates fog well. Thus, the transmitter modifications 230 are beneficial for the scenario where the wavelength transformation process is performed all optically in the receiver modifications 232.

For the scenario where the receiver device 248 comprises a nonlinear silicon detection device, electro-optical conversion is used to perform the wavelength transformation process. The wavelength, pulse transformation process may be performed using electro-optical conversion depending on the fiber interface for the user connection to the optical transceiver. Specifically, for systems transmitting sub-picosecond (˜100-fs) pulses of MWIR light, a silicon detector can be used to detect the signal directly through nonlinear multiphoton absorption processes. The silicon detector may comprise an avalanche photodiode (APD) or a diode. The higher peak energy provided by the pulse forming optics in the transmitter modifications 230 enhance the performance of the silicon detector, which produces an electronic output signal that can be used to drive a 1.55 or 1.31 um laser coupled to the network fiber 250. Alternatively, a Mercury Cadmium Tellurium (HgCdTe) detector or other fast MWIR sensor can be used in the device 248 to detect the MWIR signal and convert it to a Near IR signal. The Near IR signal can then be detected to generate an electronic signal that can be used to drive a 1.55 or 1.31 um laser coupled to the network fiber 250. Thus, the transmitter modifications 230 are beneficial for the scenario where the wavelength transformation process is performed using electro-optical conversion in the receiver modifications 232.

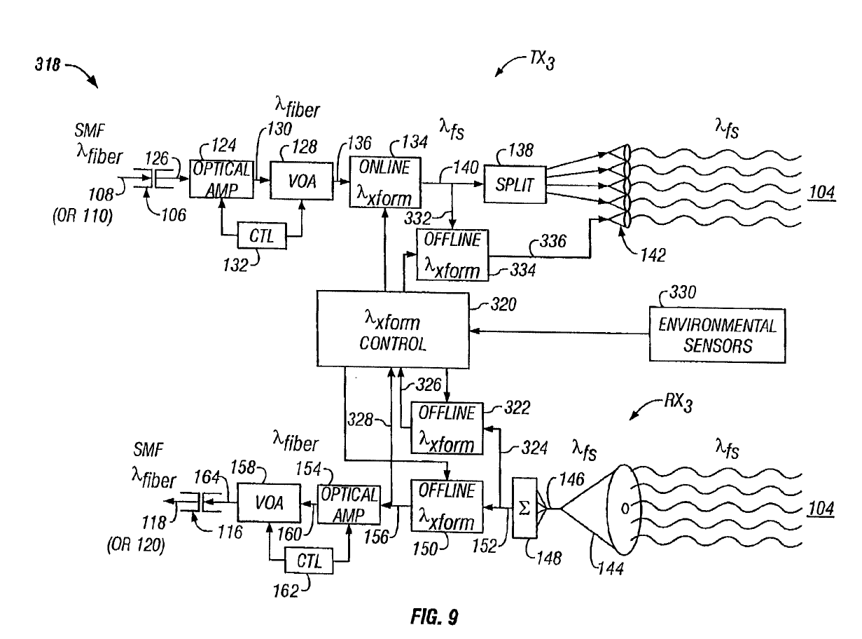

As mentioned above, the techniques employed by the transmitter and receiver modifications 230, 232 may optionally be used in any of the transmit and receive portions TXₙ, RXₙ, respectively, described herein. Thus, all of the methods and techniques described herein, such as the methods and techniques associated with FIGS. 9, 10, 11 and 12 described below, are considered to be part of the present invention for the scenario where the receive portion RXₙ performs the wavelength transformation process all-optically and the scenario where the receive portion RXₙ performs the wavelength transformation process using electro-optical conversion.

It was mentioned above that in an optional feature the present invention provides the ability to monitor the performance of the chosen value for the preferred transformed wavelength λ_{fs}, and using a feedback control system, dynamically adjust the value for λ_{fs} until the optimum value for the given atmospheric conditions is achieved. Referring to FIG. 9, there is illustrated exemplary versions of transmit and receive portions TX₃, RX₃ made in accordance with embodiments of the present invention. The transmit and receive portions TX₃, RX₃ form a transceiver 318 that may be used as one of the transceivers 100, 102. The value for the preferred transformed wavelength λ_{fs} is preferably adjusted by a configurable wavelength transform controller 320 that is coupled to and controls the online wavelength transformers 134, 150. As described above, the online wavelength transformers 134, 150 may comprise all-optical devices, such as nonlinear optics, or perform the wavelength conversions using electro-optical conversion.

The configurable wavelength transform controller 320 preferably performs an adaptive approach to wavelength selection in which an offline sampling algorithm is set to constantly find the best absorption wavelength and power through the atmosphere. If the offline performance exceeds the online performance by some threshold, then the offline configurable parameters are programmed into the configurable online wavelength transformers 134, 150 to change the wavelength to the more optimal wavelength and take advantage of the better performance gleaned from the offline wavelength.

Configurable offline wavelength transformer 322 in the receive path and configurable offline wavelength transformer 334 in the transmit path are used by the controller 320 to determine the offline performance. Specifically, a fiber optic cable 332 is coupled to the fiber optic cable 140 to provide a sample of the transmitted optical signal to the offline wavelength transformer 334. Similarly, a fiber optic cable 324 is coupled to the fiber optic cable 152 to provide a sample of the received optical signal to the offline wavelength transformer 322. A fiber optic cable 326 provides the wavelength converted optical signal from the offline wavelength transformer 322 to the controller 320. Similarly, a fiber optic cable 328 provides a sample of the wavelength converted optical signal from the online wavelength transformer 150 to the controller 320. Furthermore, one or more environmental sensors 330 may be co-located in the transceiver or located externally at any distance. The environmental sensors 330 interface to the controller 320 and are used to select the best wavelength for the given atmospheric conditions.

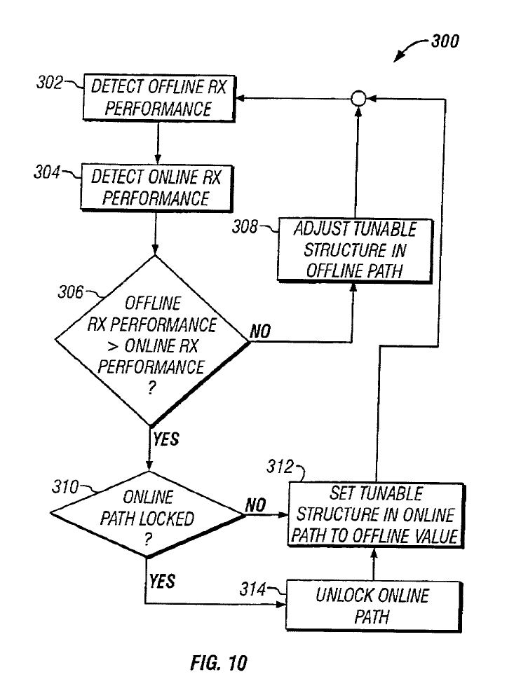

Referring to FIG. 10, there is illustrated an exemplary dynamic wavelength selection control method 300 in accordance with an embodiment of the present invention. The method 300 may be performed by the wavelength transform controller 320 or by some other external controller or processor. The performance of the chosen value for λ_{fs} is monitored by detecting the offline receive performance in step 302 and detecting the online receive performance in step 304. The offline receive performance is detected from the sample of the wavelength converted optical signal received from the offline wavelength transformer 322. The online receive performance is detected from the sample of the wavelength converted optical signal received from the online wavelength transformer 150. By way of example, such performance may be measured by detecting the optical power, receive bit error rate (BER), signal to noise ratio (SNR), etc., of the samples. Various sensors may be used to detect the receive power, including but not limited to, sensors that detect optical power, wavefront aberration, polarization, etc. In addition, the one or more environmental sensors 330 may be used to detect or measure wind, turbulence, background radiation, etc. The data collected by these sensors may be used by the controller 320 to evaluate the given atmospheric conditions and select the best wavelength λ_{fs}.

In step 306 the controller 320 determines whether or not the offline receive performance exceeds the online receive performance. By way of example, this may be done by comparing the offline receive performance and online receive performance directly, or by determining whether or not the offline receive performance is greater than a threshold level. If the offline performance does not exceed the online performance, then in step 308 the controller 320 adjusts tunable structures in the offline path. For example, the controller 320 can adjust the offline wavelength transformer 334 in the transmit path to a trial value for λ_{fs} while not disturbing the online data path. An optical signal at the trial value λ_{fs} is coupled via fiber optic cable 336 (FIG. 9) to one of the transmitting elements 142 and propagated through free-space link 104 to a cooperating receiver. Also in step 308, the controller 320 adjusts the offline receive path wavelength transformer 322 to the trial value for λ_{fs} in an effort to continue to search for offline configurable parameters that exceed online performance. In this way the controller 320 searches for a better offline value for λ_{fs}.

If, on the other hand, the offline performance does exceed the online performance, then in step 310 the controller 320 determines whether or not the wavelength in the online (i.e. primary) path is locked. If the online path is not locked, then in step 312 the tunable structures in the online paths are set or adjusted to the offline configurable parameters. In other words, the controller 320 configures the online wavelength transformer 134 in the transmit path to transmit the newly selected wavelength λ_{fs}, and the controller 320 typically also configures the online wavelength transformer 150 in the receive path to receive the newly selected wavelength λ_{fs}. Thus, the transceiver is adjusted or configured to operate at the offline value for λ_{fs}. If the online path is locked, then in step 314 the controller 320 unlocks the online path before proceeding to step 312.

By using the method 300 the value for the preferred transformed wavelength λ_{fs} is changed or adjusted dynamically using a feedback control system that monitors the performance of the chosen wavelength through the atmosphere. The process for finding the optimal wavelength λ_{fs} may be done iteratively or using a stochastic process. An iterative method involves incrementally sweeping the configurable parameters to located the best performance in the receiver. A stochastic approach uses a random approach that statistically will not get stuck in a local minimum.

In a free-space optical communications system employing the transceivers 100, 102 (FIG. 1), a given optical transmitter TX may communicate with a single, remotely located receiver RX (point-to-point) or many receivers RX (point-to-multipoint). The transmitted wavelength λ_{fs} may differ from the fiber optic wavelength λ_{fiber} by an offset determined by the transmitter TX's local wavelength transformer (e.g., 134, 170). Furthermore, the transmitted wavelength λ_{fs} may be time varying according to the dynamic wavelength selection control method 300 (FIG. 10) described above. Therefore, the present invention provides methods whereby the wavelength transformer (e.g., 150, 172) in the receiver(s) RX perform a wavelength transform operation equal and opposite to that applied by the transmitter TX.

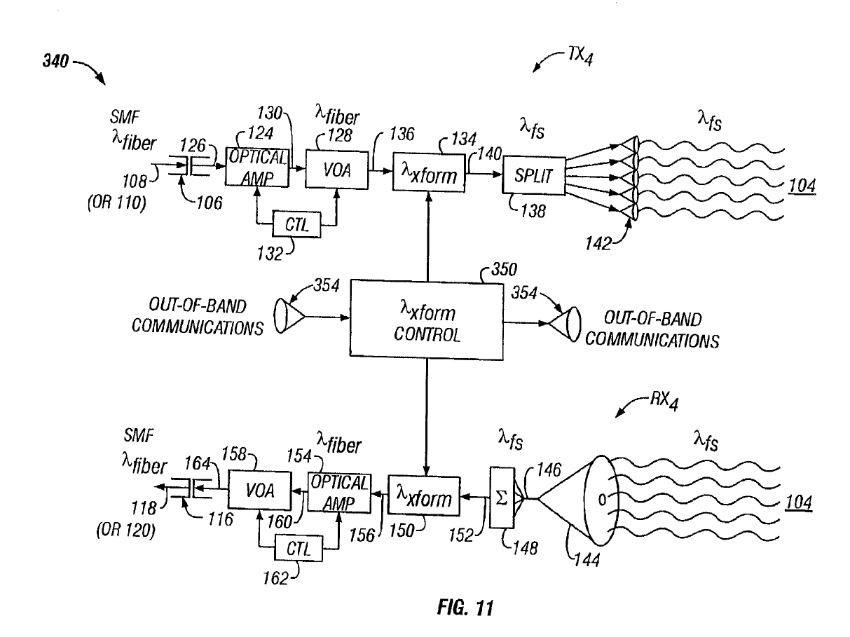

For example, FIG. 11 illustrates exemplary versions of transmit and receive portions TX₄, RX₄ made in accordance with an embodiment of the present invention. The transmit and receive portions TX₄, RX₄ form a transceiver 340 that may be used as one of the transceivers 100, 102. The transceiver 340 includes a wavelength transform controller 350 made in accordance with an embodiment of the present invention. The wavelength transform controller 350 is coupled to and controls the wavelength transformer 134 in the transmit portion TX₄ and the wavelength transformer 150 in the receive portion RX₄.

The transceiver 340 employs a method of establishing coherent data communications by communicating with cooperating transceiver(s) at the other end of the free-space link 104 via an out-of-band control communications channel 354. The direct, out-of-band control communications channel 354 is coupled to the wavelength transform controller 350 and enables direct communications between cooperating transceivers. By way of example, the communications channel 354 may take various forms such as, but not limited to, wire-line (telephone modem, LAN, etc.), wireless RF (cellular, microwave radio, etc.), free-space optical (infrared LED, fixed reserved wavelength laser, etc.), etc. By way of further example, the communications channel 354 may utilize methods or devices described in U.S. patent application Ser. No. 09/482,782, filed Jan. 13, 2000, entitled HYBRID WIRELESS OPTICAL AND RADIO FREQUENCY COMMUNICATION LINK, by inventors Heinz Willebrand and Maha Achour, the entire contents of which are hereby fully incorporated into the present application by reference.

During operation, the transceiver 340 may select a more optimum transmission wavelength λ_{fs}, such as for example by using the dynamic wavelength selection control method 300 (FIG. 10). If the transceiver 340 does select a new transmission wavelength λ_{fs}, the transceiver 340 can inform cooperating transceiver(s) of the new λ_{fs} via the direct out-of-band control communications channel 354. This way the one or more cooperating transceiver(s) can adjust their wavelength transformers to apply the indicated wavelength value λ_{fs} in order to maintain coherent communications over the data channel. Specifically, the cooperating transceivers will adjust the wavelength transformer in the receive portion RX to convert the indicated value λ_{fs} to the fiber optic wavelength λ_{fiber} so that the receive portion RX performs a wavelength transform operation equal and opposite to that applied by the wavelength transformer 134 in the transmit portion TX₄. The cooperating transceivers will also adjust the wavelength transformer in their transmit portion TX to convert the fiber optic wavelength λ_{fiber} to the indicated value λ_{fs}.

Similarly, if a cooperating transceiver selects a new transmission wavelength λ_{fs}, the cooperating transceiver can inform the transceiver 340 of the new λ_{fs} via the out-of-band control communications channel 354. The transceiver 340 then uses this information to determine the appropriate wavelength transform amount to be applied by its own transmit and receive portions TX₄, RX₄. Specifically, the controller 350 adjusts the wavelength transformer 150 in the receive portion RX₄ accordingly so that the requisite fiber optic output wavelength is reestablished, and the controller 350 adjusts the wavelength transformer 134 in the transmit portion TX₄ accordingly in order to transmit the new transmission wavelength λ_{fs}.

As another example, FIG. 12 illustrates exemplary versions of transmit and receive portions TX₅, RX₅ made in accordance with an embodiment of the present invention. The transmit and receive portions TX₅, RX₅ form a transceiver 342 that may be used as one of the transceivers 100, 102. Here, an adaptive wavelength selection determination is utilized by the transceiver 342 in order to determine the appropriate wavelength transform amount to be applied by the transmit and receive portions TX₅, RX₅. The adaptive wavelength selection determination involves the receive portion RX₅ continuously monitoring the received signal's wavelength and adaptively adjusting its wavelength transformation values in response to locally measured changes in the received signal's wavelength.

More specifically, a wavelength transform controller 352 is coupled to and controls the wavelength transformer 134 in the transmit portion TX₅ and the wavelength transformer 150 in the receive portion RX₅. A beam sampler 356 is optically coupled from the fiber optic cable 140 in the transmit portion TX₅ to the controller 352 via two fiber optic cables 358, 360. Another beam sampler 362 is optically coupled from the focus element 146 in the receive portion RX₅ to the controller 352 via two fiber optic cables 364, 366.

During operation, the receive portion RX₅ receives signals that are transmitted over the free-space link 104 by a cooperating transmitter. A sample of the received optical beam, which may be broadband in nature, is routed from the focus element 146 of the receive portion RX₅, through the beam sampler 362, and to the controller 352. Similarly, a sample of the transmitted optical beam is routed from the fiber optic cable 140 of the transmit portion TX₅, through the beam sampler 356, and to the controller 352. In the controller 352 the received wavelength is compared to the current value of the transmitted wavelength. A difference between the two wavelengths implies that the cooperating (or sending) free-space optical transceiver has determined that a better value for the transmission wavelength λ_{fs} exists and has therefore changed to that value. By way of example, the cooperating transceiver may determine the better value for the transmission wavelength λ_{fs} by using the dynamic wavelength selection control method 300 (FIG. 10). The controller 352 adjusts the wavelength transformer 150 in the receive portion RX₅ to apply the indicated better value for λ_{fs} in response to the measured deviation in order to match the current received wavelength. Specifically, the wavelength transformer 150 is adjusted to convert the indicated better value for λ_{fs} to the fiber optic wavelength λ_{fiber}. Similarly, the controller 352 adjusts the wavelength transformer 134 in the transmit portion TX₅ to apply the indicated better value for λ_{fs}. In this way the transceiver 342 uses an adaptive method to maintain coherent communications over the data channel.

It should be understood that the configurable online wavelength transform controllers 350, 352 (FIGS. 11, 12, respectively) may each comprise a single device in one location or more than one device in more than one location. For example, a separate controller may be associated with each transmit and receive portion TX, RX. Furthermore, the wavelength transform controllers 350, 352 may be located onboard each transceiver or located externally.

By way of example, with respect to the receiving element 144, the focus element 146, and the fiber combiner 148 shown in FIGS. 3, 5, 9, 11 and 12, coupling from free-space to a single or multi-mode mode fiber may be achieved using the broadband coupling devices and techniques described in U.S. patent application Ser. No. 09/849,613, filed May 4, 2001, entitled TERRESTRIAL OPTICAL COMMUNICATION NETWORK OF INTEGRATED FIBER AND FREE-SPACE LINKS WHICH REQUIRES NO ELECTRO-OPTICAL CONVERSION BETWEEN LINKS, by inventors Heinz Willebrand and Gerald R. Clark, and identified as Attorney Docket No. 70646 (7293), the entire contents of which are hereby fully incorporated into the present application by reference.

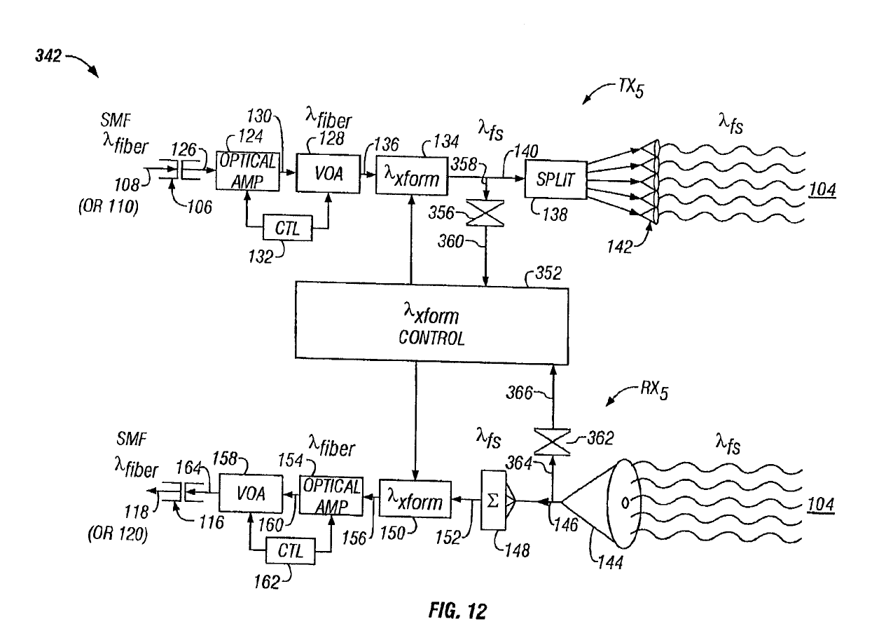

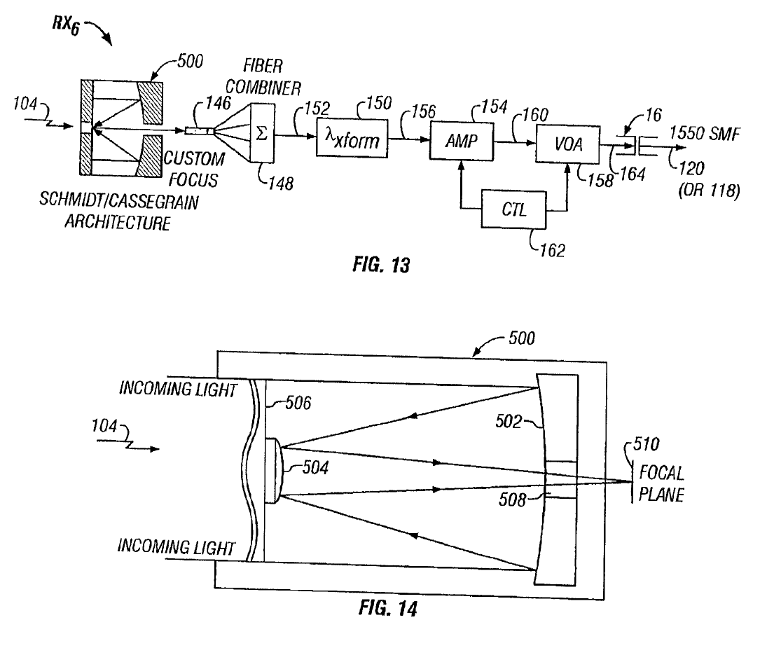

By way of further example, the receiving element 144, the focus element 146, and the fiber combiner 148 may be constructed and operated in accordance with the following discussion. Specifically, FIG. 13 illustrates an exemplary version of a receive portion RX₆ made in accordance with an embodiment of the present invention. The receive portion RX₆ may be used in the transceivers 100, 102. In this version, the one or more receiving elements 144 comprise the Catadioptric (e.g. Schmidt-Cassegrain, Maksutov and others) telescope architecture 500, which directs the received light into the focus element 146. The Schmidt-Cassegrain telescope architecture, which is a well-known architecture, uses a combination of mirrors and lenses to fold the optics and form an image. It has several advantages. Specifically, the Schmidt-Cassegrain design is a compact optical system that delivers high resolution images over a wide field and spectral band, combining the optical advantages of both mirrors and lenses, while minimizing their disadvantages. Secondary focal ratios are generally in the range of f/10. Finally, the Schmidt-Cassegrain architecture has one of the best near focus capabilities of any type of telescope design, and it has a relatively large aperture compared with refractive objectives to collect more light. While the Schmidt-Cassegrain telescope may be used in the present invention, it should be well understood that telescopes or other focusing devices of various other designs may alternatively be used in accordance with the present invention.

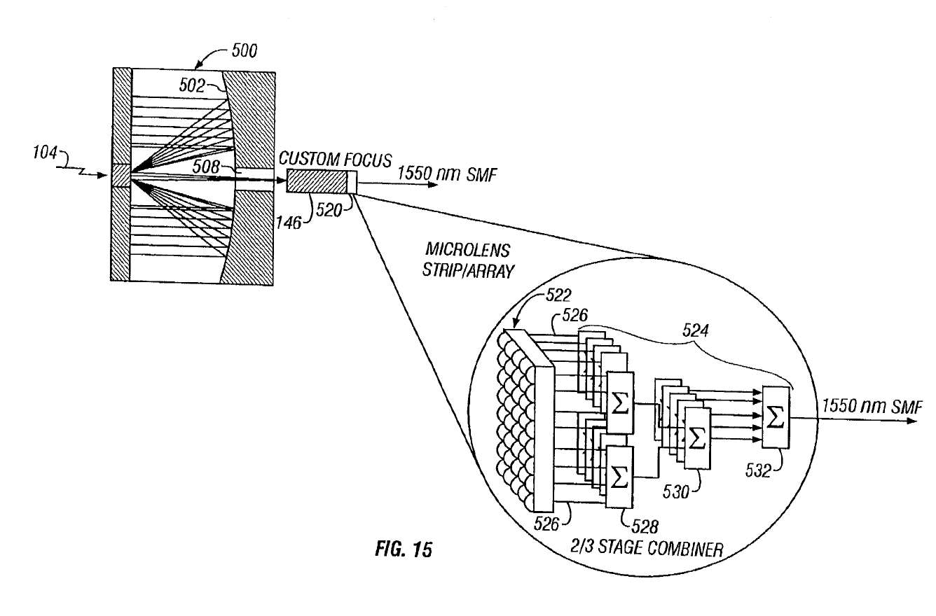

FIG. 14 illustrates the Schmidt-Cassegrain architecture 500 in further detail. Incoming light from the free-space link 104 is received from the left-hand side. The incoming light enters through a thin aspheric Schmidt plate (or corrector) 506, then strikes the spherical primary mirror 502 and is reflected back up the tube. The light is then intercepted by a small secondary mirror 504 which reflects the light out an opening 508 in the rear of the instrument, where the image is formed at the focal plane 510. Referring to FIG. 15, there is illustrated one technique in accordance with an embodiment of the present invention for coupling the light received from the free-space link 104 into the 9.0 um core SMF in the receive portion RX. Specifically, according to this technique, the Schmidt-Cassegrain architecture 500 receives light from the free-space link 104. The far end 520 of the focus element 146 includes a microlens strip/array 522 along with an optical combiner stage 524.

During operation the light from the output of the Schmidt-Cassegrain architecture 500 is directed onto the array of microlenses 522. The light beams output from the array of microlenses 522 are directed into corresponding SMFs 526, which are then combined into a single light beam by the optical combiner stage 524. The optical combiner stage 524 combines the light using a waveguide, such as an arrayed waveguide, until all of the received light is in an SMF matching the fiber interface of the connectors 106, 116 (FIGS. 2 and 3). By way of example, the optical combiner stage 524 may comprise a multi-stage combiner (or equivalent device), such as a two-stage or three-stage (2/3-stage) combiner. In the illustrated example, the optical combiner stage 524 comprises a three-stage combiner, having fiber combiner stages 528, 530, 532. In this way the light received from the free-space link 104 is coupled to the 1550 nm SMF with no electro-optical conversion. The light is then wavelength converted by the wavelength transformer 150 and amplified by the multi-wavelength fiber amplifier 154.

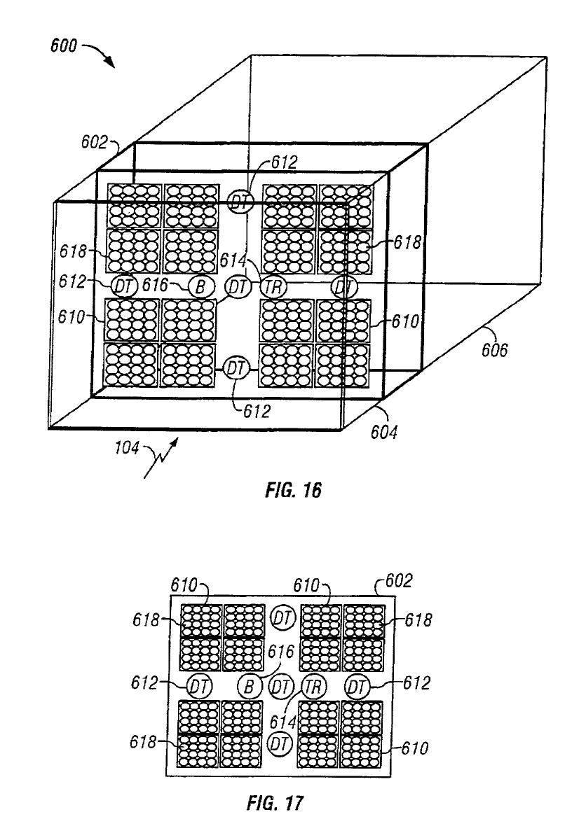

Referring to FIG. 16, there is illustrated an alternative transceiver architecture 600 in accordance with another embodiment of the present invention. The architecture 600, which provides an alternative to the Schmidt-Cassegrain receiver, features a single tracker for both receive and transmit and a compact 50 mm receiver path length. The architecture 600 includes a compact opto-mechanical assembly 602, an infrared (IR) window 604, and a bay 606 for housing electronics and gimbal drives.

The IR window 604 provides a filter window to cover and protect the opto-mechanical assembly 602 and to reduce thermal effects from, for example, sunlight. Use of the IR window 604 avoids the need for a filter on every individual lens. The IR window 604 preferably comprises an 850/1550 nm bandpass filter window. While the IR window 604 is illustrated as having a square shape, it should be understood that the IR window 604 may comprise many different shapes.

FIGS. 17, 18, 19, 20 and 21 illustrate the compact optical assembly 602 in further detail. In this embodiment, the compact optical assembly 602 includes sixteen receiver arrays 610, five data transmitters (DT) 612, a tracker (Tr) 614, and a beacon (B) 616. The receiver arrays 610, data transmitters 612, tracker 614, and beacon 616 are mounted on a gimbal mount (not shown).

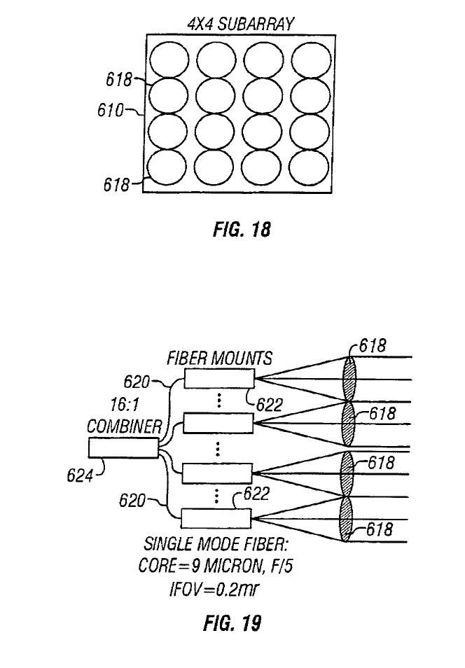

With respect to the data receiver objective, each receiver array 610 preferably includes sixteen 9 mm lenses 618 (also referred to as microlenses), which forms a 4×4 subarray of lenses 618, as shown in FIG. 18. Thus, the sixteen receiver arrays 610 form a 16×16 array of 9 mm lenses 618. By way of example, various options for the lenses 618 include: conic singlet, CC=−0.58; and Gradium GPX-10-45, Diffractive, Doublet. Exemplary specifications for the lenses 618 include: EFL=45 mm; Diameter=9 mm, CA F/5 matches fiber; Spot size<9 um.

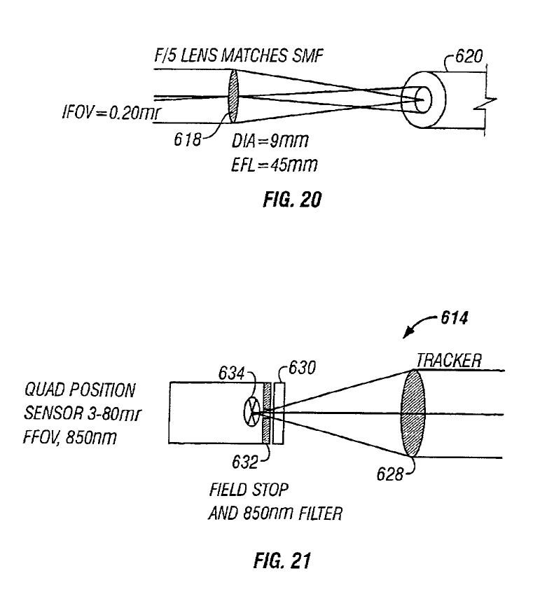

During operation the light received from the free-space link 104 is directed through the IR window 604 and onto the array of lenses 618. FIGS. 19 and 20 illustrate a manner in which the light received from the free-space link 104 through the lenses 618 can be coupled into the 0.9 um core SMF 620.

Specifically, each of the sixteen lenses 618 in the array 610 directs light into a respective one of sixteen SMFs 620, which are each secured by a respective one of sixteen fiber mounts 622 (only four lenses 618, four SMFs 620, and four fiber mounts 622 are illustrated). The 9 mm (45 mm EFL) F/5 lenses 618 match the 9.0 um core SMF 620. By way of example, the SMF 620 may have an instantaneous field of view (IFOV)=0.20 mr.

The sixteen SMFs 620 secured by the sixteen fiber mounts 622 are combined in a 16:1 combiner 624. Because there is a separate 16:1 combiner 624 for each of the sixteen receiver arrays 610, an additional 16:1 combiner (not shown) is used to combine the outputs of the sixteen 16:1 combiners 624. In this way the light received by the compact optical assembly 602 is coupled to a single SMF using no electro-optical conversion.

FIG. 21 illustrates an exemplary embodiment of the tracker 614. As mentioned above, the tracker 614, along with the other components in the compact optical assembly 602, are mounted on a gimbal mount (not shown). The tracker 614 and the gimbal mount slew the optical assembly 602, and only one tracker is required. Light received through a tracker lens 628 is directed through an 850 nm filter 630 and a field stop 632. The light then impinges on a quad position sensor 634, which is used for sensing beam position. By way of example, the quad position sensor 630 may comprise a 3-80 mr full field of view (FFOV), 850 nm sensor.

While the invention herein disclosed has been described by means of specific embodiments and applications thereof, numerous modifications and variations could be made thereto by those skilled in the art without departing from the scope of the invention set forth in the claims.

What is claimed is:

1. A method of communicating optical signals over a free-space link, comprising the steps of:
receiving a first optical signal having a fiber interface fundamental wavelength from a first single mode optical fiber;
converting the fiber interface fundamental wavelength of the first optical signal to a free-space fundamental wavelength with a transmit wavelength transformer;
directing the first optical signal having the free-space fundamental wavelength over the free-space link;
receiving a second optical signal having the free-space fundamental wavelength from the free-space link;
converting the free-space fundamental wavelength of the second optical signal to a fiber interface fundamental wavelength with a receive wavelength transformer; and
directing the second optical signal having the fiber interface fundamental wavelength into a second single mode optical fiber.

2. A method in accordance with claim 1, wherein the step of converting the fiber interface fundamental wavelength of the first optical signal to a free-space fundamental wavelength is performed all-optically without using electro-optical conversion.

3. A method in accordance with claim 2, wherein the step of converting the free-space fundamental wavelength of the second optical signal to a fiber interface fundamental wavelength is performed all-optically without using electro-optical conversion.

4. A method in accordance with claim 2, wherein the step of converting the free-space fundamental wavelength of the second optical signal to a fiber interface fundamental wavelength is performed using optical-to-electrical conversion.

5. A method in accordance with claim 1, further comprising the steps of:
sampling a portion of the second optical signal having the free-space fundamental wavelength; and
using the sampled portion of the second optical signal in an offline path to determine a new value for the free-space fundamental wavelength.

6. A method in accordance with claim 5, wherein the step of using the sampled portion of the second optical signal in an offline path to determine a new value for the free-space fundamental wavelength comprises the step of:
comparing a detected offline performance with a detected online performance.

7. A method in accordance with claim 5, further comprising the step of:
reconfiguring the transmit wavelength transformer to convert the fiber interface fundamental wavelength of the first optical signal to the new value for the free-space fundamental wavelength.

8. A method in accordance with claim 1, further comprising the step of:
receiving an indication of a new value for the free-space fundamental wavelength via an out-of-band communications channel.

9. A method in accordance with claim 8, further comprising the step of:
reconfiguring the transmit wavelength transformer to convert the fiber interface fundamental wavelength of the first optical signal to the new value for the free-space fundamental wavelength.

10. A method in accordance with claim 1, further comprising the step of:
sampling a portion of the first optical signal having the free-space fundamental wavelength;
sampling a portion of the second optical signal having the free-space fundamental wavelength;
comparing a wavelength of the sampled portion of the first optical signal to a wavelength of the sampled portion of the second optical signal.

11. A method in accordance with claim 10, further comprising the step of:
reconfiguring the transmit wavelength transformer in response to a measured deviation between the wavelength of the sampled portion of the first optical signal and the wavelength of the sampled portion of the second optical signal.

12. An apparatus for communicating optical signals over a free-space link, comprising:
means for receiving a first optical signal having a fiber interface fundamental wavelength from a first single mode optical fiber;
a transmit wavelength transformer configured to convert the fiber interface fundamental wavelength of the first optical signal to a free-space fundamental wavelength;
a transmitting element configured to direct the first optical signal having the free-space fundamental wavelength over the free-space link;
a receiving element configured to receive a second optical signal having the free-space fundamental wavelength from the free-space link;
a receive wavelength transformer configured to convert the free-space fundamental wavelength of the second optical signal to a fiber interface fundamental wavelength; and
means for directing the second optical signal having the fiber interface fundamental wavelength into a second single mode optical fiber.

13. An apparatus in accordance with claim 12, wherein the transmit wavelength transformer comprises an apparatus for converting the fiber interface fundamental wavelength of the first optical signal to a free-space fundamental wavelength all-optically without using electro-optical conversion.

14. An apparatus in accordance with claim 13, wherein the receive wavelength transformer comprises an apparatus for converting the free-space fundamental wavelength of the second optical signal to the fiber interface fundamental wavelength all-optically without using electro-optical conversion.

15. An apparatus in accordance with claim 13, wherein the receive wavelength transformer comprises an apparatus for converting the free-space fundamental wavelength of the second optical signal to the fiber interface fundamental wavelength using optical-to-electrical conversion.

16. An apparatus in accordance with claim 12, further comprising:
a controller configured to compare a detected offline performance with a detected online performance to determine a new value for the free-space fundamental wavelength.

17. An apparatus in accordance with claim 16, wherein the controller is further configured to reconfigure the transmit wavelength transformer to convert the fiber interface fundamental wavelength of the first optical signal to the new value for the free-space fundamental wavelength.

18. An apparatus in accordance with claim 12, further comprising:
an out-of-band communications channel configured to receive an indication of a new value for the free-space fundamental wavelength.

19. An apparatus in accordance with claim 18, further comprising:
a controller configured to reconfigure the transmit wavelength transformer to convert the fiber interface fundamental wavelength of the first optical signal to the new value for the free-space fundamental wavelength.

20. An apparatus in accordance with claim 12, further comprising:
a controller configured to compare a wavelength of a sampled portion of the first optical signal to a wavelength of a sampled portion of the second optical signal.

21. An apparatus in accordance with claim 20, wherein the controller is further configured to reconfigure the transmit wavelength transformer in response to a measured deviation between the wavelength of the sampled portion of the first optical signal and the wavelength of the sampled portion of the second optical signal.

22. A method of communicating optical signals over a free-space link, comprising the steps of:
receiving a first optical signal having a fiber interface fundamental wavelength from a first single mode optical fiber;
amplifying the first optical signal with a multi-wavelength optical amplifier connected in-line with the first single mode optical fiber;
attenuating the first optical signal with a variable optical attenuator that is optically coupled to the multi-wavelength optical amplifier;
converting the fiber interface fundamental wavelength of the first optical signal to a free-space fundamental wavelength with a transmit wavelength transformer; and
directing the first optical signal having the free-space fundamental wavelength over the free-space link.

23. A method in accordance with claim 22, wherein the step of converting the fiber interface fundamental wavelength of the first optical signal to a free-space fundamental wavelength is performed all-optically without using electro-optical conversion.

24. A method in accordance with claim 22, further comprising the step of:
reconfiguring the transmit wavelength transformer to convert the fiber interface fundamental wavelength of the first optical signal to a new value for the free-space fundamental wavelength.

25. A method in accordance with claim 24, further comprising the step of:
comparing a detected offline performance with a detected online performance to determine the new value for the free-space fundamental wavelength.

26. A method in accordance with claim 24, further comprising the step of:
receiving an indication of the new value for the free-space fundamental wavelength via an out-of-band communications channel.

27. A method in accordance with claim 24, further comprising the step of:
sampling a portion of the first optical signal having the free-space fundamental wavelength;
receiving a second optical signal having the free-space fundamental wavelength from the free-space link;
sampling a portion of the second optical signal having the free-space fundamental wavelength; and
comparing a wavelength of the sampled portion of the first optical signal to a wavelength of the sampled portion of the second optical signal to determine the new value for the free-space fundamental wavelength.

28. A method in accordance with claim 22, further comprising the step of:
controlling a power gain of the multi-wavelength optical amplifier and a dynamic attenuation provided by the variable optical attenuator.

29. An apparatus for communicating optical signals over a free-space link, comprising:
means for receiving a first optical signal having a fiber interface fundamental wavelength from a first single mode optical fiber;
a multi-wavelength optical amplifier connected in-line with the first single mode optical fiber for amplifying the first optical signal;
a variable optical attenuator that is optically coupled to the multi-wavelength optical amplifier for attenuating the first optical signal;
a transmit wavelength transformer configured to convert the fiber interface fundamental wavelength of the first optical signal to a free-space fundamental wavelength; and
one or more transmitting elements configured to direct the first optical signal having the free-space fundamental wavelength over the free-space link.

30. An apparatus in accordance with claim 29, wherein the transmit wavelength transformer comprises an apparatus for converting the fiber interface fundamental wavelength of the first optical signal to a free-space fundamental wavelength all-optically without using electro-optical conversion.

31. An apparatus in accordance with claim 29, further comprising:
a controller configured to reconfigure the transmit wavelength transformer to convert the fiber interface fundamental wavelength of the first optical signal to a new value for the free-space fundamental wavelength.

32. An apparatus in accordance with claim 31, wherein the controller is further configured to compare a detected offline performance with a detected online performance to determine the new value for the free-space fundamental wavelength.

33. An apparatus in accordance with claim 31, wherein the controller is further configured to receive an indication of the new value for the free-space fundamental wavelength via an out-of-band communications channel.

34. An apparatus in accordance with claim 29, further comprising:
a controller configured to control a power gain of the multi-wavelength optical amplifier and an attenuation provided by the variable optical attenuator.

35. A method of communicating optical signals over a free-space link, comprising the steps of:
receiving a first optical signal having the free-space fundamental wavelength from the free-space link;
converting the free-space fundamental wavelength of the first optical signal to a fiber interface fundamental wavelength with a receive wavelength transformer;
amplifying the first optical signal with a multi-wavelength optical amplifier optically coupled to the receive wavelength transformer;
attenuating the first optical signal with a variable optical attenuator that is optically coupled to the multi-wavelength optical amplifier; and
directing the first optical signal having the fiber interface fundamental wavelength into a first single mode optical fiber.

36. A method in accordance with claim 35, wherein the step of converting the free-space fundamental wavelength of the first optical signal to a fiber interface fundamental wavelength is performed all-optically without using electro-optical conversion.

37. A method in accordance with claim 35, wherein the step of converting the free-space fundamental wavelength of the first optical signal to a fiber interface fundamental wavelength is performed using optical-to-electrical conversion.

38. A method in accordance with claim 35, further comprising the step of:
reconfiguring the receive wavelength transformer to convert a new value for the free-space fundamental wavelength of the first optical signal to the fiber interface fundamental wavelength.

39. A method in accordance with claim 38, further comprising the step of:
comparing a detected offline performance with a detected online performance to determine the new value for the free-space fundamental wavelength.

40. A method in accordance with claim 38, further comprising the step of:
receiving an indication of the new value for the free-space fundamental wavelength via an out-of-band communications channel.

41. A method in accordance with claim 38, further comprising the step of:
sampling a portion of the first optical signal having the free-space fundamental wavelength;
comparing a wavelength of the sampled portion of the first optical signal to a wavelength of a sampled portion of the second optical signal to determine the new value for the free-space fundamental wavelength.

42. A method in accordance with claim 35, further comprising the step of:
controlling a power gain of the multi-wavelength optical amplifier and an attenuation provided by the variable optical attenuator.

43. An apparatus for communicating optical signals over a free-space link, comprising:
a receiving element configured to receive a first optical signal having the free-space fundamental wavelength from the free-space link;
a receive wavelength transformer configured to convert the free-space fundamental wavelength of the first optical signal to a fiber interface fundamental wavelength;
a multi-wavelength optical amplifier optically coupled to the receive wavelength transformer for amplifying the first optical signal;
a variable optical attenuator that is optically coupled to the multi-wavelength optical amplifier for attenuating the first optical signal; and
means for directing the first optical signal having the fiber interface fundamental wavelength into a first single mode optical fiber.

44. An apparatus in accordance with claim 43, wherein the receive wavelength transformer comprises an apparatus for converting the free-space fundamental wavelength of the first optical signal to the fiber interface fundamental wavelength all-optically without using electro-optical conversion.

45. An apparatus in accordance with claim 43, wherein the receive wavelength transformer comprises an apparatus for converting the free-space fundamental wavelength of the first optical signal to the fiber interface fundamental wavelength using optical-to-electrical conversion.

46. An apparatus in accordance with claim 43, further comprising:
a controller configured to reconfigure the receive wavelength transformer to convert a new value for the free-space fundamental wavelength of the first optical signal to the fiber interface fundamental wavelength.

47. An apparatus in accordance with claim 46, wherein the controller is further configured to compare a detected offline performance with a detected online performance to determine the new value for the free-space fundamental wavelength.

48. An apparatus in accordance with claim 46, wherein the controller is further configured to receive an indication of the new value for the free-space fundamental wavelength via an out-of-band communications channel.

49. An apparatus in accordance with claim 46, wherein the controller is further configured to compare a wavelength of a sampled portion of the first optical signal to a wavelength of a sampled portion of a second optical signal to determine the new value for the free-space fundamental wavelength.

50. An apparatus in accordance with claim 43, further comprising:
a controller configured to control a power gain of the multi-wavelength optical amplifier and an attenuation provided by the variable optical attenuator.
